(19) United States
(12) Patent Application Publication
(10) Pub. No.: US 2013/0195198 A1
(43) Pub. Date: Aug. 1, 2013

(54) REMOTE PROTOCOL

(71) Applicant: Splashtop Inc., San Jose, CA (US)

(72) Inventors: Yu Qing Tim CHENG, San Jose, CA (US); Wen-Pin TSAI, Taipei (TW)

(73) Assignee: SPLASHTOP INC., San Jose, CA (US)

(21) Appl. No.: 13/747,283

(22) Filed: Jan. 22, 2013

Related U.S. Application Data
(60) Provisional application No. 61/589,744, filed on Jan. 23, 2012.

(51) Int. Cl. H04N 7/26

(52) U.S. Cl. CPC H04N 19/00775
USPC 375/240.18; 375/240.01

(57) ABSTRACT

A system and method are provided for a hybrid approach to delivering digital imagery in real-time that improves CPU utilization and latency. Such hybrid approach includes using standard compression/decompression utilities, such as but not limited to H.264 encoding/decoding, as well as a novel technique that creates and advantageously employs a block of data containing essentially the blocks of data that are difference from the previous input.

### CROSS REFERENCE TO RELATED APPLICATIONS

This patent application claims priority from U.S. provisional patent application Ser. No. 61/589,744, REMOTE PROTOCOUMULTI-TRACK VIDEO, filed Jan. 23, 2012, the entirety of which is incorporated herein by this reference thereto.

### BACKGROUND OF THE INVENTION

1. Technical Field

This invention relates generally to the field of rendering bit streams to digital images. More specifically, this invention relates to an improved technique for delivering real-time digital frames, e.g. real-time video.

2. Description of the Related Art

Remote technology allows a user to access his or her computer, e.g. work computer, at a remote location, e.g. at the office, from a different location, e.g.

from home. For example, a user who is taking a day off at home because he is sick, may still desire to work from home. Such user, through remote technology, is able to access his computer to work on a pending project, for example, on a presentation.

As computing devices become more and more advanced, for remote technology to be useful, remote technology includes techniques for delivering real-time video and audio. In the example above, suppose the user is at the editing stage of a video demonstration for his presentation. Such user, who is sick and may also be under a deadline, may want to access his video presentation, which is on the office computer, from his home device. Or, a user may want to simply watch from home a movie that is resident on his office computer. Thus, remote technology may involve streaming technology.

One such streaming technology is H.264/MPEG-4 AVC (“H.264”), developed by the ITU-T Video Coding Experts Group (VCEG) together with the International Organization for Standardization (ISO)/International Electrotechnical Commission (IEC) joint working group and the Moving Picture Experts Group (MPEG). H.264 which is considered by one skilled in the art as a video compression standard and is used for recording, compression, and delivering high definition video.

### SUMMARY OF THE INVENTION

A system and method are provided for a hybrid approach to delivering digital imagery in real-time that improves CPU utilization and latency. Such hybrid approach includes using standard compression/decompression utilities, such as but not limited to H.264 encoding/decoding, as well as a novel technique that creates and advantageously employs a block of data containing essentially the blocks of data that are different from the previous input.

### BRIEF DESCRIPTION OF THE DRAWINGS

FIG. 1 is a block schematic diagram that shows one or more flows for delivering digital imagery, such as video, in accordance with an embodiment; and

FIG. 2 is a block schematic diagram of a system in the exemplary form of a computer system according to an embodiment.

### DETAILED DESCRIPTION OF THE INVENTION

A system and method are provided for a hybrid approach to delivering digital imagery in real-time that improves CPU utilization and latency. Such hybrid approach includes using standard compression/decompression utilities, such as but not limited to H.264 encoding/decoding, as well as a novel technique that creates and advantageously employs a block of data containing essentially the blocks of data that are difference from the previous input.

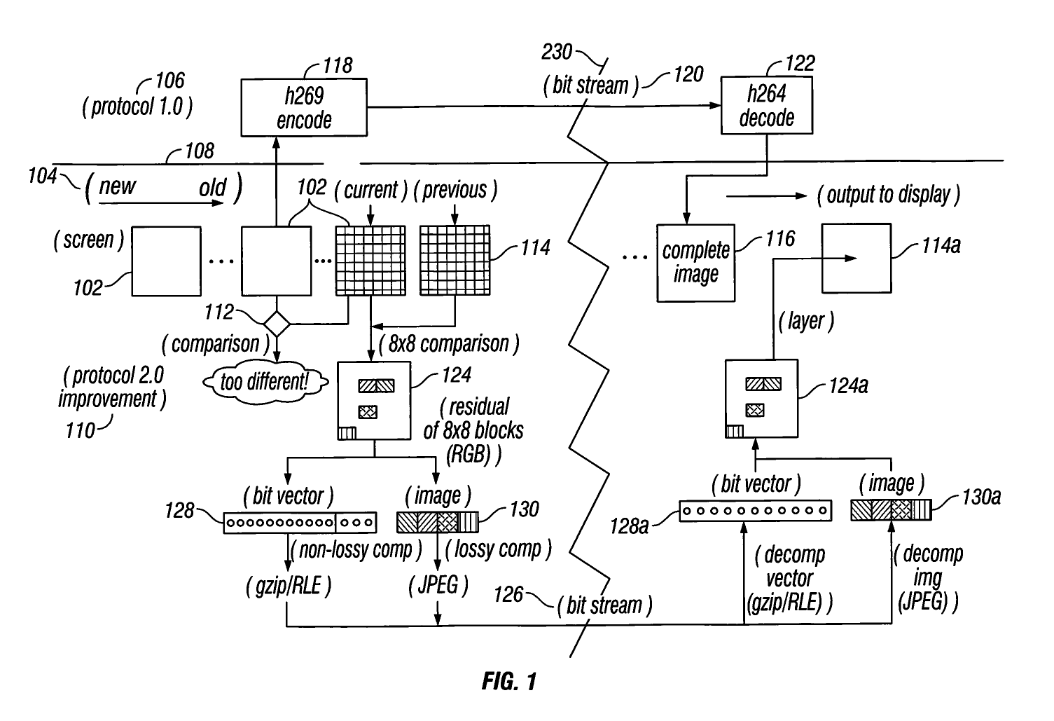

An embodiment can be understood with reference to FIG. 1. FIG. 1 is a block schematic diagram showing entities, one or more of which may be generated on the fly, and their respective relationships in a context of flow from left to right. For purposes of understanding herein, FIG. 1 may represent one or more methods for achieving improved real-time rendering of digital imagery or a system on which such one or more methods may be performed, i.e. individually or collectively referred to herein as “system.” As an example, a screen 102 is considered input into the system and/or flow, in accordance with an embodiment. Thus, a legend 104 is provided to indicate that the progression of new screens to old screens runs from left to right.

In an embodiment, standard encoding and decoding techniques may be incorporated. Referring to FIG. 1, such standard encoding/decoding technique is depicted visually as being referred to as protocol 1.0 106. As well, protocol 1.0 106 is further depicted, for illustrative purposes only, as being on a top part of a line 108. The bottom part of line 108 is referred to as protocol 2.0 for the purposes of understanding herein only and is not meant to be otherwise limiting.

It should be appreciated that screen 102 may also be considered a frame, a part of a screen or frame, or any portion of a multimedia input, which one skilled in the art would readily recognize as being input into the system.

In an embodiment, when screen 102 arrives at the system, a decision is made 112 about whether screen 102 is too different from a previous screen 114. For purposes of understanding herein, “too different” may include but is not limited to a comparison of 8×8 blocks of colors in RGB format of screen 102 to correlating blocks in screen 114. In an embodiment, too different may be considered as a threshold number of changes, e.g. 8×8 blocks that have changed, when compared against the previous frame.

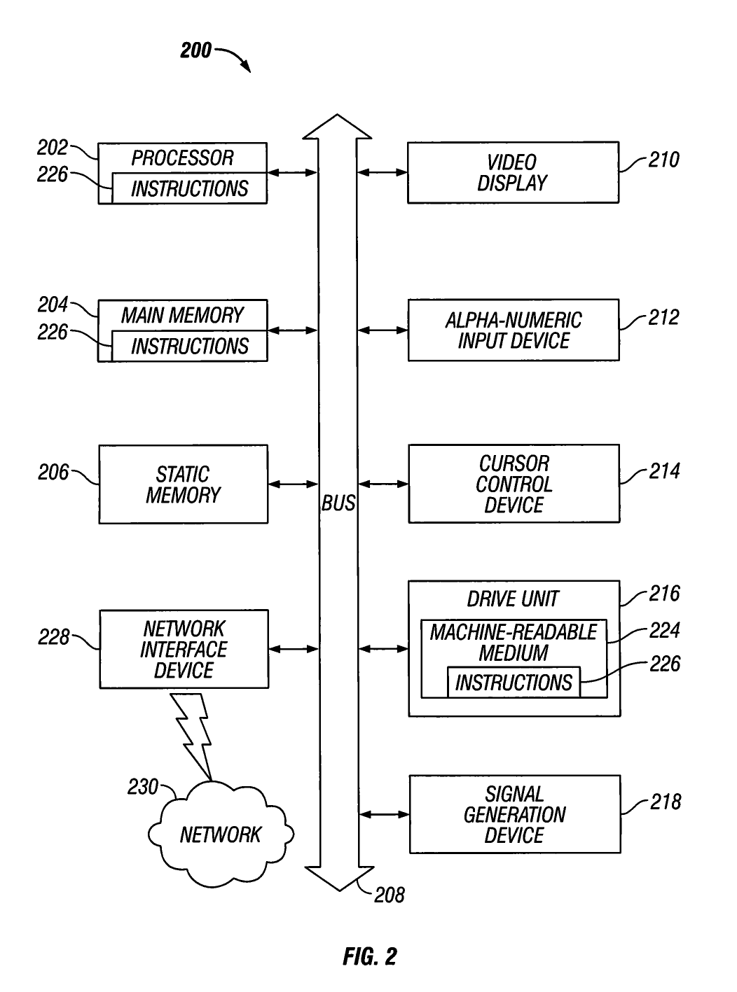

In an embodiment, when there is no previous screen, e.g. when screen 102 is a first screen of a video to be rendered, such screen 102 may be rendered into a complete image 116 by available compression techniques, such as but not limited to H.264. Thus, for example and as shown in FIG. 1, screen 102 may be input into a H.264 encoder 118 for compression. Compressed screen 102 may then be sent as a bit stream 120 over a network 230 to a decoder 122, e.g. a decoder in a remote device such as but not limited to a smart phone or other mobile device (not shown.) Network 230 is described in further detail hereinbelow in FIG. 2. Then, decoder 122 generates complete image 116, which is ready to be output to a display (not shown.)

In an embodiment, when screen 112 is determined to be too different from previous 114, it may be preferable to encode screen 112 using protocol 1.0 106 techniques.

In an embodiment, when it is determined that screen 112 is not too different from previous 114, a block of residual data is generated 124. An example of creating the residual data may be achieved by but is not limited to a pixel-by-pixel subtraction or XOR operation on an 8×8 block. For example, the system may perform a series of comparisons of 8×8 RGB blocks and keep only those blocks of screen 112 which are different from previous 114, as depicted in screen 124.

In an embodiment, the tasks of comparison, residual generation, e.g. creating bit vector 128, may be performed in one pass with optimized SSE/AVX. It should be appreciated that such operation may be accelerated on GPU to offload CPU, because such operation may be highly parallelizable. In an embodiment, RLE may be performed potentially in the same pass.

In an embodiment, optimizations may include but are not limited to starting from a known difference spot and stop comparing every frame when many changes in the last few frames have been detected. For example, in an embodiment an optimization may include a threshold number of consecutive frames that triggers a video encode compression path. For example, a video may play for an initial set of frames, i.e. before a threshold is crossed, and each frame is compared against the previous one. However, once the system observes every frame requires video encode path, the system stops the comparison on subsequent frames to save CPU loading.

In an embodiment, residual block screen 124 may contain only or in part per-pixel changes to further reduce the amount of information. In an embodiment, screen 124 may contain only that data which is different or may contain other data that may serve other purposes. For example, in an embodiment screen 124 may contain extra data blocks for the purposes of improving screen resolution at the display. In an embodiment, screen 124 may contain other data blocks that may contain metadata in other data blocks for purposes of transferring informational data having to do with the video, but not having to do with tracking the pixel changes.

In an embodiment, screen 124 may be transformed into a bit stream 126 for sending over network 230 to the other device (not shown.) In an embodiment, screen 124 may be translated into a bit vector 128 or an image 130 for transport. It should be appreciated that one skilled in the art would readily recognize that bit vector 128 and image 130 are by ways of example only and are not meant to be limiting.

For instance, the system may be configured to translate screen 124 into bit vector 128 when it is desired that the encoding be non-lossy compression, such as for example in gzip and run length encoding (RLE.) In an embodiment, bit vector 128 stores the location of the changed 8×8 blocks. Other non-lossy compression embodiments may include but are not limited to any of: RLE (as mentioned above), LZ78, Gzip (DEFLATE), Bzip2, LZMA, and LZO.

As well, the system may be configured to translate screen 124 into image 130, e.g. JPEG, which comprises the changed data, e.g. changed 8×8 blocks, such as for example when it is desired that the encoding be lossy compression. Other lossy compression embodiments may include but are not limited to any of: JPEG, JPEG2000, and PNG.

In an embodiment, the system is configured to render such bit stream 126, regardless of format. Thus, for example, when bit stream 126 is sent over network 230 to the remote device, the system allows for bit stream 126 to be decompressed, e.g. by using gzip or RLE, into bit vector 128a or to be decompressed into image 130a, e.g. by using JPEG.

In an embodiment, after bit stream 126 has been received and rendered into bit vector 128a and/or image 130a, a screen 124a is created thereof. It should be appreciated that screen 124a correlates to screen 124 in that, among other things, screen 124a contains the residual data from the comparison of screen 112 with previous 114.

In an embodiment, after screen 124a is generated, the system may overlay the previous screen, screen 114a. Put another way, screen 124a is a layer that is placed on top of screen 114a to render the change that is present in screen 112 when compared to screen 114. Then, screen 114a is sent as output to the display.

In an embodiment, the layering step may be performed directly on the screen incrementally. For example, the system may show changes immediately, as opposed to waiting for a full frame to be decoded and/or transferred. As changed blocks come in, such blocks may show up immediately on the screen for lower latency. A downside may be “tearing” effects. For better video quality, the next image typically is buffered in the background and only flipped to the front of the screen when all changes are completely painted.

It should be appreciated that the embodiments described hereinabove reflect a hybrid approach to delivering real-time imagery. Such hybrid approach comprises, among other things, using standard and available compression/decompression of entire images as well as using the compression/decompression of residual data, such as the 8×8 blocks.

It should be appreciated that one skilled in the art would readily appreciate that bit stream 126 requires a smaller sideband than bit stream 120, which contains data of an entire image. As well, it has been found that the system works well with video being delivered at a rate of 30 frames per second with low latency. As well, it should be appreciated that the system decreases latency and CPU utilization on both sides, e.g. the encoder side and the decoder side, during productivity.

It should be appreciated that in an embodiment, the QP or JPEG may be dynamically adjusted based on a required amount of changes. For purposes of understanding herein, QP stands for quantization parameter in JPEG and H.264 encoding. Such parameter dictates the picture quality of the resulting image/video. For example, the system may detect a video playing based on observing the inter-frame and intra-frame changes and decide to use a lower QP value, because the artifacts may be less obvious in a moving video. However, when the system detects a productivity software running, such system may use a higher QP value to make the text and images sharper and with less compression artifacts on the screen.

An embodiment may include but is not limited to intra-frame switching. For purposes of understanding herein, intra-frame switching is switching from or to compression of the entire image, e.g. H.264, to or from differencing per frame, e.g. creating the residual block, within a frame. For example, inside a single frame, an embodiment identifies a rectangle that is video and sends such video through the H.264 path. In the embodiment, the remaining data within the frame goes through the differencing path. Identification may be performed through algorithmically analyzing the difference bit vector or may be through analyzing running applications, e.g. media player window coordinates. In an embodiment, the video window has to stay the same for some frames to pay off. Re-positioning the video window may require resetting h264 codec, which may require a high overhead. It should be appreciated that, herein, most of the description of the algorithm is about determining frame-by-frame whether to use standard video compression or a separate compression path. This paragraph is about inside one frame, splitting the image into a rectangle that may be fed into a video compression engine, and the rest into a separate compression path.

### An Example Machine Overview

FIG. 2 is a block schematic diagram of a system in the exemplary form of a computer system 200 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 200 includes a processor 202, a main memory 204 and a static memory 206, which communicate with each other via a bus 208. The computer system 200 may further include a display unit 210, for example, a liquid crystal display (LCD) or a cathode ray tube (CRT). The computer system 200 also includes an alphanumeric input device 212, for example, a keyboard; a cursor control device 214, for example, a mouse; a disk drive unit 216, a signal generation device 218, for example, a speaker, and a network interface device 228.

The disk drive unit 216 includes a machine-readable medium 224 on which is stored a set of executable instructions, i.e. software, 226 embodying any one, or all, of the methodologies described herein below. The software 226 is also shown to reside, completely or at least partially, within the main memory 204 and/or within the processor 202. The software 226 may further be transmitted or received over a network 230 by means of a network interface device 228.

In contrast to the system 200 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to access real-time video delivery on such internet-enabled or other network-enabled devices, servers, or clients in accordance with embodiments herein. It further should be appreciated that one or more cloud computing embodiments include real-time video delivery using mobile devices, tablets, and the like, as such devices are becoming standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for transporting and presenting video over a network, comprising the steps of:
receiving, by a receiving processor, a screen;
determining, by a determining processor, whether said screen is too different from a previous screen;
when said previous screen does not exist or when is it determined that said screen is too different from said previous screen, then creating a complete image from said screen by using standard compression/decompression techniques over a network, wherein said complete image is ready to be output to a display;
when it is determined that said screen is not too different from said previous screen, generating, by a generating processor, a block of residual data;
in response to generating said residual data, transforming, by a transforming processor, said residual data into a bit vector or image for transport;
transporting, by a transporting processor, said bit vector or image as a compressed bit stream over said network for decompressing;
in response to transporting said compressed bit stream over the network, decompressing, by a decompressing processor, said bit stream into a second bit vector or a second image;
generating, by a generating processor, a second residual data from said second bit vector or said second image; and
layering, by a layering processor, said second residual data on top of a second previous screen to render a change that is present in said screen when compared to said previous screen, wherein said layered second previous screen is ready to be output to said display.

2. The method of claim 1, wherein the screen is a frame, a part of a screen or frame, or any portion of a multimedia input.

3. The method of claim 1, wherein said determining comprises any of:
comparing 8×8 blocks of colors of said screen to correlating 8×8 blocks in said previous screen; and
determining whether a threshold number of changes have occurred when said screen is compared with said previous screen.

4. The method of claim 1, wherein said generating a block of residual data comprises a pixel-by pixel subtraction or XOR operation on an 8×8 block.

5. The method of claim 1, wherein said generating a block of residual data comprises keeping only those blocks of said screen which are different from said previous screen.

6. The method of claim 1, wherein said residual data is transformed into a bit vector when it is desired that the encoding be non-lossy compression.

7. The method of claim 1, wherein said residual data is transformed into an image when it is desired that the encoding be lossy compression.

8. The method of claim 1, wherein said layering is performed directly on said second previous screen incrementally.

9. The method of claim 1, further comprising dynamically adjusting, by an adjusting processor, a quantization parameter or JPEG based on a required amount of changes.

10. The method of claim 1, further comprising intra-frame switching from or to compression of an entire image to or from differencing per frame.

11. A system for transporting and presenting video over a network, comprising:
a receiving processor for receiving a screen;
a determining processor for determining whether said screen is too different from a previous screen;
a creating processor for, when said previous screen does not exist or when is it determined that said screen is too different from said previous screen, creating a complete image from said screen by using standard compression/decompression techniques over a network, wherein said complete image is ready to be output to a display;
a generating processor for generating a block of residual data, when it is determined that said screen is not too different from said previous screen;
a transforming processor for transforming said residual data into a bit vector or image for transport, in response to generating said residual data;
a transporting processor for transporting said bit vector or image as a compressed bit stream over said network for decompressing;
a decompressing processor for decompressing said bit stream into a second bit vector or a second image, in response to transporting said compressed bit stream over the network;
a generating processor for generating a second residual data from said second bit vector or said second image; and
a layering processor for layering said second residual data on top of a second previous screen to render a change that is present in said screen when compared to said previous screen, wherein said layered second previous screen is ready to be output to said display.

12. The system of claim 11, wherein the screen is a frame, a part of a screen or frame, or any portion of a multimedia input.

13. The system of claim 11, wherein said determining comprises any of:
comparing 8×8 blocks of colors of said screen to correlating 8×8 blocks in said previous screen; and
determining whether a threshold number of changes have occurred when said screen is compared with said previous screen.

14. The system of claim 11, wherein said generating a block of residual data comprises a pixel-by pixel subtraction or XOR operation on an 8×8 block.

15. The system of claim 11, wherein said generating a block of residual data comprises keeping only those blocks of said screen which are different from said previous screen.

16. The system of claim 11, wherein said residual data is transformed into a bit vector when it is desired that the encoding be non-lossy compression.

17. The system of claim 11, wherein said residual data is transformed into an image when it is desired that the encoding be lossy compression.

18. The system of claim 11, wherein said layering is performed directly on said second previous screen incrementally.

19. The system of claim 11, further comprising an adjusting processor for dynamically adjusting a quantization parameter or JPEG based on a required amount of changes.

20. The system of claim 11, further comprising an intra-frame processor for intra-frame switching from or to compression of an entire image to or from differencing per frame.
